(19) United States
(12) Patent Application Publication
(10) Pub. No.: US 2008/0120916 A1
(43) Pub. Date: May 29, 2008

(54) Method of creating a fabric storm cover for an opening in a building

(75) Inventors: Stephen J. Borona, Pensacola, FL (US); Darius H. Grimes, Cantonment, FL (US)

Correspondence Address: Andrew B. Morton;RENNER, KENNER, GREIVE, BOBAK, TAYLOR & WEBER, Fourth Floor, First National Tower, Akron, OH, 44308-1456, US

(73) Assignee: Wayne-Dalton Corp.

(21) Appl. No.: 11/516,967

(22) Filed: Sep. 8, 2006

(51) Int. Cl. E06B 3/30; E06B 9/00

(52) U.S. Cl. 49/506; 160/405

(57) ABSTRACT

A method of constructing a fabric storm cover (15) to protect an opening (11) in a structure (12) includes the steps of determining the orientation of grommets (14) to be inserted into a fabric panel (10), determining the size of the opening (11), selecting the amount of overlap of the edges not having the grommets (14), determining the grommet span (C), and selecting a panel (10) from a plurality of panels based on the determined grommet span (C). Once the panel (10) is selected, the maximum allowable distance between the grommets (14) is determined, and then the grommets (14) are positioned through thickened areas (13) in the panel (10) at a distance (D) not to exceed the maximum allowable distance.

### TECHNICAL FIELD

This invention relates to a fabric storm protection cover for an opening in a building. More particularly, this invention relates to a method of creating such a cover according to the size of the opening to be covered and the construction parameters of the building.

### BACKGROUND ART

In geographic areas which are prone to having high wind events, such as hurricanes and the like, the need exists for the protection of openings, such as windows and doors, in buildings. Otherwise, if the high winds or wind-borne debris breaches the integrity of the structure by destroying a window or door, severe damage to the structure can be expected.

In its most simple form, one type of known protection device which can be utilized is a simple sheet of plywood which can be attached to the structure so as to cover the openings thereof. However, this “boarding up” procedure is not only time consuming, when time is usually of the essence, but also can disfigure the exterior of the structure upon frequent installation and removal. Moreover, storing and maintaining an inventory of plywood sheets can be problematic.

As a result, a number of temporarily installable or permanently installed devices have been developed to be used as alternatives to plywood. For example, metallic shutters consisting of a plurality of hinged slats can be provided adjacent to a window and can be rolled up by a hand crank or a motor when not in use. However, these devices are not only costly, but also they do not provide the necessary seal irrespective of whether they are mounted on the windward or leeward side of the building.

More recently, fabric-based systems have been developed which are much less costly than the metallic shutters or other devices, and which can provide a cover for the openings in the structure. In their simplest form, these systems include a sheet of fabric which is strong enough to withstand high winds and the forces of wind borne debris without rupturing. These fabric sheets typically are provided with spaced openings along two opposed edges and fasteners are positioned in the structure at corresponding spaced locations so that they can be received through the openings in the fabric to attach the fabric to the structure.

One problem associated with the fabric storm covers just described is that the manufacturer must make, and the retailer must stock, a multitude of various sized covers for use with a wide variety of sizes of openings found in buildings. Although such can always be custom manufactured, this procedure not only takes time, but can significantly add to the cost. Ideally, the raw fabric could be provided to a contractor or a do-it-yourself user who could then create his own custom cover, but to date no one, prior to the applicants herein, have devised such a system

### DISCLOSURE OF THE INVENTION

It is thus an object of the present invention to provide a method of designing and creating custom fabric storm covers for openings in a building.

It is another object of the present invention to provide a method, as above, which can readily be performed by the owner of the building to create his own storm cover.

These and other objects of the present invention, as well as the advantages thereof over existing prior art forms, which will become apparent from the description to follow, are accomplished by the improvements hereinafter described and claimed.

In general, a method of constructing a fabric storm cover for an opening in a structure includes the steps of determining the dimensions of the cover needed to protect the opening, selecting a fabric panel from a plurality of panels, cutting the selected panel in accordance with the size of one of the determined dimensions, and positioning grommets in the selected panel.

A preferred exemplary method of the present invention used to construct a storm cover shown in the accompanying drawings is described herein without attempting to show and describe all the variations in which the invention might be embodied, the invention being measured by the appended claims and not by the details of the specification.

### BRIEF DESCRIPTION OF THE DRAWINGS

FIG. 1 is a fragmented, elevational view of a fabric panel used to make a storm protection cover in accordance with the concepts of the present invention.

FIG. 2 is a perspective view of an opening in the form of a window, in a portion of a structure to be protected by the storm cover.

FIG. 3 is an elevational view of the storm cover created by the method of the present invention.

FIG. 4 is a somewhat schematic representation of a fastener used to attach the storm cover to the structure.

### PREFERRED EMBODIMENT FOR CARRYING OUT THE INVENTION

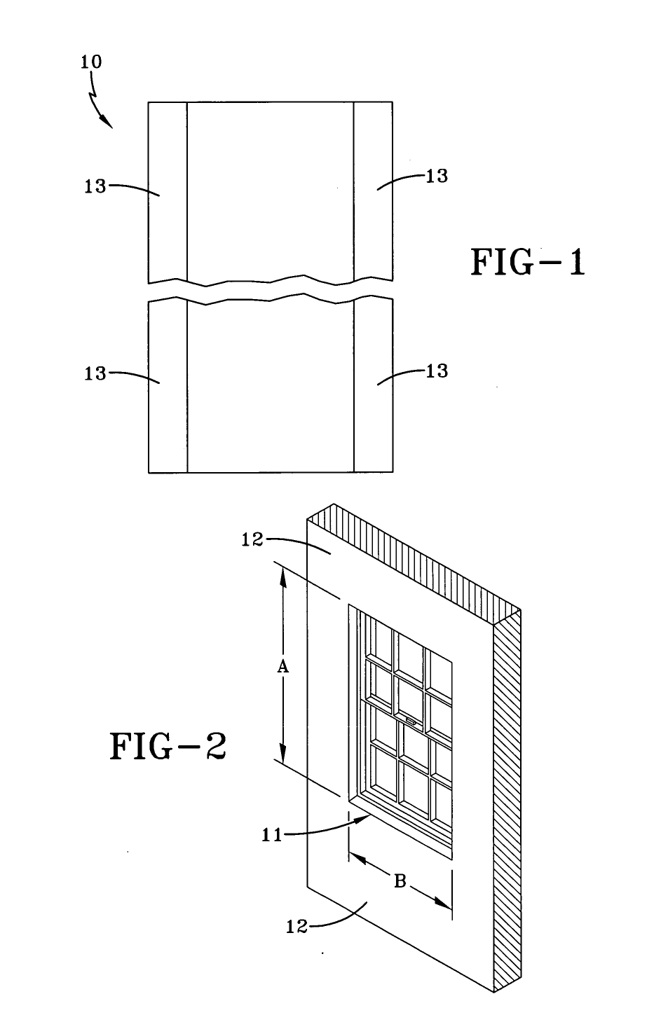

The method of the present invention is intended to utilize one or more fabric panels, generally indicated by the numeral 10 and shown in FIG. 1, to cover and protect an opening, such as a window 11 in a structure 12 as shown in FIG. 2.

Panels 10 are preferably made of a fabric material which can withstand the forces of wind and airborne debris as are often encountered in a hurricane or the like. Exemplarily fabric for such a panel 10 is disclosed in U.S. patent application Ser. No. 11/190,114 filed on Jul. 25, 2005, to which reference is made for whatever details may be necessary to understand the present invention.

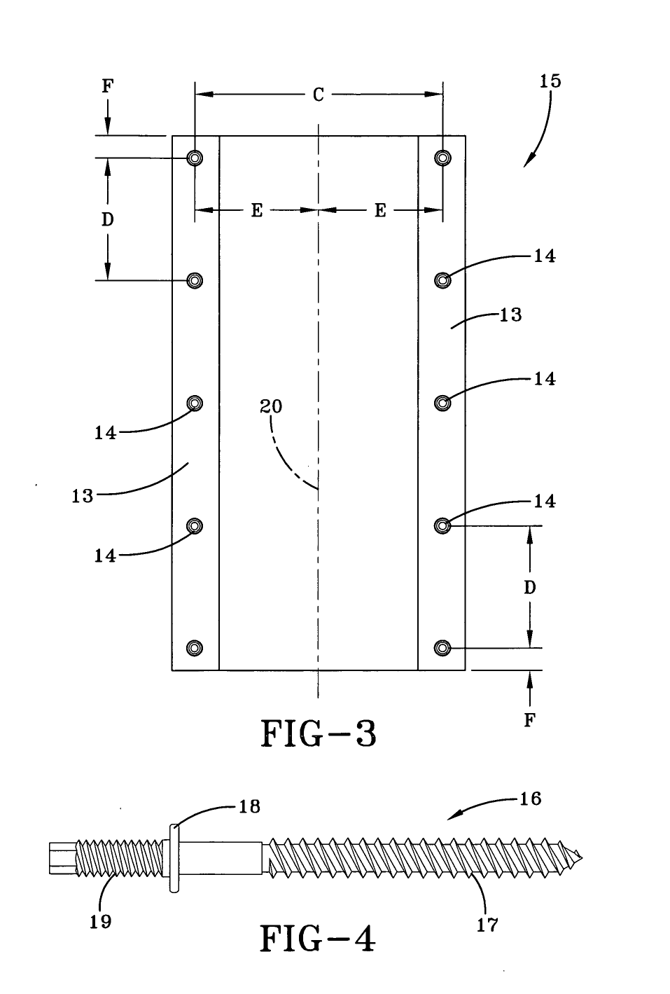

As will hereinafter be described in more detail, fabric panels 10 may be supplied by the manufacturer in a number of widths, with the desired width to be selected by the user. Panel 10 may also be provided in a variety of lengths, with eight or six feet in length being typical, and may be cut to the proper length by the user. Panels 10 include thickened areas 13 along their side edges which run the entire length of each panel 10. Thickened areas 13 are typically formed of three plies of the fabric material which can be attached to each other as by sonic welding, heat sealing, sewing or the like. The thickened areas 13 are thus three times the thickness of the rest of the fabric of each panel 10 and are preferably approximately six and one-quarter inches wide irrespective of the width of each panel 10. As will be hereinafter discussed, the thickened areas receive grommets 14 therethrough, as shown in FIG. 3, to enable the storm cover 15 formed from a panel 10 to be attached to the structure 12.

The first step in creating a storm cover 15 is to determine whether the grommets 14 will be on the sides of the window 11, that is, spaced left-to-right (as shown in FIG. 3), or whether they will be above the top of the window 11 and below the sill thereof, that is, spaced top-to-bottom. In order to determine this orientation, it has been found that two factors must be considered—one, the type of framing for structure 12 must be identified, that is, wood, concrete block, or hollow block; and two, whether the sill of the window 11 protrudes from the wall of the structure 12. For wood framing walls or for hollow and concrete block with a protruding window sill, the cover 15 would be mounted with the grommets left-to-right. For hollow and concrete block without protruding sills, the cover can be mounted in either the left-to-right or top-to-bottom grommet configuration. For purposes of the example to be discussed herein, it will be assumed that structure 12 is of a wood frame construction, and therefore, the grommets 14 will be on the sides of the window 11 in the left-to-right orientation.

Next, the size of the opening of the window 11 must be determined. The height A (FIG. 2) of the opening is measured from the top of the sill to the top of the opening, even if the sill is protruding, and the width B is measured from side to side of the opening, as shown. For purposes of the example to be discussed herein, it will be assumed that the measured height A is sixty inches, and the measured width B is thirty-six inches.

It is preferable, but not required, that there be an overlap of the fabric on the unfastened edges of the cover 15, that is, the edges not having the grommets 14. Thus, in the example, the overlap would be on the top and the bottom of the window 11. An overlap of at least one inch is preferred, and thus, the overall height of the cover 15 of the example, with one-inch overlaps, is sixty-two inches.

The next step in the construction/design process for cover 15 is to determine the “grommet span” C, that is, the distance between the grommets on the left side and the grommets on the right side, or the distance between the top and bottom grommets if oriented in that direction. A factor in this determination is the desired or required “fastener set back,” that is, how far onto the structure that the grommets and fasteners should be placed relative to the edges of the window opening. For concrete block and wood frame structures 12, this set back should be approximately two inches on each side of the window opening, and for hollow block structure 12, the set back should be approximately three inches on each side of the window opening. For the example of a wood frame structure and a thirty-six-inch window opening width, a grommet span of forty inches is determined.

As previously described, it is convenient for a panel manufacturer to provide panels 10 in a variety of widths with the user selecting and purchasing the particular panel desired in accordance with the required grommet span C. Each panel 10 is designed to accommodate a range of grommet spans with the width of the panels being such that for the largest grommet span accommodated, the grommets will be at least an inch and one-half away from the edge, and for the smallest grommet span accommodated, the grommets will still be within thickened area 13. Table I shows eight panels to select from and the maximum and minimum grommet spans (in inches) accommodated by those panels, although it should be appreciated that more or less than eight panel sizes could be provided.

TABLE I

GROMMET SPAN

| PANEL | WIDTH | MAXIMUM | MINIMUM |
|---|---|---|---|
| A | 39 | 28 | 36 |
| B | 48 | 37 | 45 |
| C | 57 | 46 | 54 |
| D | 66 | 55 | 63 |
| E | 75 | 64 | 72 |
| F | 84 | 73 | 81 |
| B | 93 | 82 | 90 |
| H | 102 | 91 | 99 |

### In the example being considered, which requires a forty-inch grommet span, the user would select Panel B for further processing.

Since the panels 10 are in eight-foot, or possibly six-foot, lengths, as previously described, the selected panel 10 must be cut to the desired length. Thus, in the example, selected Panel B is cut to the desired sixty-two-inch length.

The next step in the cover design process is to determine the distance D between the grommets 14 along each side of window 11. To determine this distance, as a starting point, the maximum grommet spacing which will still protect the window 11 should be determined. In other words, if the grommets 14 are spaced too far apart, the cover 15 will not be able to adequately protect the window 11. On the other hand, placing the grommets 14 closer together would needlessly add to the expense of the product while unnecessarily increasing its strength.

The maximum allowable grommet distance is a function of the panel selected, the type of framing of structure 12, the wind zone in the geographic area where the cover is being installed, and the fasteners being employed to attach the cover to the structure. The framing, that is, wood, concrete, or hollow block, has been previously discussed. The wind zone is expressed in miles per hour of wind speed and is obtainable from the building officials of the geographic area of the user. The selection of the fasteners is dictated by the thickness of the exterior finish (vinyl or aluminum siding, stucco, brick, or the like) and the desired fastener penetration. While many fasteners would be commercially available and usable to attach covers 15 to the structure 12, a fastener known as TAPCON SG sold by ITW/Buildex of Itasca, Ill., or a fastener known as PANELMATE PRO sold by Textron-Elco of Troy, Mich., would be suitable for all applications except for brick exterior finishes. For brick exteriors, a PANELMATE TVAS fastener sold by Textron-Elco would be recommended. Representative of the configuration of those fasteners is shown in FIG. 4 as fastener 16. All of these fasteners would extend through the openings in the grommet 14 and have a portion 17 which penetrates into the structure 12. They also have a washer 18 which rests against the structure 12 when portion 17 is fully penetrated into the structure 12. A threaded portion 19 of fastener 16 extends through the opening in each grommet 14 and a wing nut (not shown) may be secured to portion 19. In this manner, the cover 15 is held adjacent to the window 11 or other opening in the structure 12 to be protected. Such a fastening system is shown in the aforementioned U.S. patent application Ser. No. 11/190,114 filed on Jul. 25, 2005, incorporated herein.

A maximum grommet spacing chart can be provided for each Panel size A-H, which shows how the framing, wind zone, and fastener dictate the maximum grommet spacing. Table II shows the chart just for the Panel B selected for the example being discussed herein, it being understood that a complete chart would include each panel A-H.

TABLE II
Maximum Grommet Spacing
Panel B

| | TAPCON SG | | | PANELMATE PRO | | | PANELMATE TVAS | | |
|---|---|---|---|---|---|---|---|---|---|
| Wind Speed | | | Hollow | | | Hollow | | | Hollow |
| MPH | Wood | Concrete | Block | Wood | Concrete | Block | Wood | Concrete | Block |
| 110 | 12 | 12 | 12 | 12 | 12 | 12 | 11 | 11 | 9 |
| 120 | 12 | 12 | 12 | 12 | 12 | 12 | 11 | 11 | 9 |
| 130 | 12 | 12 | 12 | 12 | 12 | 12 | 10 | 10 | 8 |
| 140 | 12 | 12 | 12 | 12 | 12 | 11 | 8 | 8 | 7 |

As is evident, if the TAPCON SG or PANELMATE PRO fasteners are selected, except for the 140 mile per hour wind zone using a PANELMATE PRO fastener for hollow block, a twelve-inch maximum grommet spacing is recommended. It should be noted, of interest, that if the PANELMATE TVAS fastener is used for a brick exterior finish, the maximum grommet spacing varies from eleven inches down to seven inches depending on the framing and wind zones.

The next step in the design of a cover is the placement of the grommets in the thickened areas 13 of the Panel B which has been cut to its sixty-two-inch length. To do so, the centerline 20 of the panel is determined and the grommet span C is divided by two, resulting in a dimension E. That distance is then measured from centerline 20 which locates the grommets within thickened areas 13 and spaced left-to-right by distance C, to determine the grommet span. In the example being used herein, the panel is forty-eight-inches wide, and with a grommet span of forty inches, the grommets will be placed four inches from the outer edges of Panel B. It is preferable to place the top and bottom grommets on each side, that is, the four corner grommets, one and one-half inches from the top and bottom edges (dimension F). Thus, in the example being discussed, the corner grommets will be placed one and one-half inches from the top and bottom, and four inches from the left and right edges. As a result, in the example of a sixty-two-inch long panel, the corner grommets will be fifty-nine inches apart.

The remaining grommets on the left and right sides of the panel are preferably evenly spaced at a distance not to exceed the maximum grommet distance determined from Table II. Thus, in the example under discussion, where the corner grommets will be fifty-nine inches apart, four more grommets could be added between them and their spacing would be just under the twelve-inch maximum grommet distance. Or, if one wanted to be ultra-safe, five more grommets could be added rendering their spacing at just under ten inches.

With the location for the grommets thus established, they can be installed by simply drilling or otherwise creating holes in cover 15 at those locations and, using a conventional grommet tool, then setting the grommets at those locations. The custom-made cover 15 is then complete and ready to install over the window 11. To do so, one merely needs to set the selected fasteners 16 in structure 12 at locations corresponding to the locations of grommets 14 and attach cover 15 to the structure 12 as previously described.

It should thus be evident that a fabric storm cover constructed according to the method described herein substantially improves the art and otherwise accomplishes the objects of the present invention.

What is claimed is:

1. A method of constructing a fabric storm cover for an opening in a structure comprising the steps of determining the dimensions of the cover needed to protect the opening, selecting a fabric panel from a plurality of panels, cutting the selected panel in accordance with the size of one of the determined dimensions, and positioning grommets in the selected panel.

2. The method of claim 1 wherein the opening has length and width dimensions and further comprising the step of determining whether the grommets will span the length or the width dimensions.

3. The method of claim 2 wherein the step of determining whether the grommets will span the length or the width dimension includes the step of identifying the type of framing of the structure.

4. The method of claim 3 wherein the opening is a window and the step of determining whether the grommets will span the length or width dimension includes the step of determining whether the window has a sill protruding from the structure.

5. The method of claim 2 further comprising the step of determining the desired grommet span.

6. The method of claim 5 wherein the step of selecting a fabric panel is dependent upon the determined desired grommet span.

7. The method of claim 5 wherein the step of determining the desired grommet span includes the step of determining the set back for the fasteners used to attach the cover to the structure.

8. The method of claim 7 wherein the step of determining the set back is dependent on the type of framing of the structure.

9. The method of claim 7 wherein the desired grommet span is determined by adding the determined set back to the dimension that the grommets will span.

10. The method claim 2 wherein the determined dimension for the step of cutting the panel is the length or width dimension not spanned by the grommets plus a selected overlap.

11. The method of claim 1 wherein the grommets are selectively positioned either spaced along the top and bottom or spaced along the sides of the cover.

12. The method of claim 11 further comprising the step of determining the maximum allowable spacing between the grommets.

13. The method of claim 12 wherein the step of determining the maximum allowable spacing is dependent on the selected panel.

14. The method of claim 13 wherein the step of determining the maximum allowable spacing includes the steps of determining the type of framing of the structure, determining the wind zone in which the structure is located, and determining the type of fastener to be employed to attach the cover to the structure.

15. The method of claim 14 wherein the step of determining the type of fastener includes the steps of determining the thickness of the exterior finish of the structure and considering the desired penetration of the fastener into the structure.

16. The method of claim 1 wherein the selected fabric panel has thickened areas along two opposed edges to receive the grommets and the step of positioning includes the step of locating the position of the grommets in the thickened areas.

17. The method of claim 16 wherein the step of locating includes the step of determining the span between the grommets from one edge to the other edge.

18. The method of claim 17 wherein the step of locating includes the step of identifying the centerline of the panel, dividing the determined grommet span by two, and locating the grommets a distance from the centerline equal to the determined grommet span divided by two.

19. The method of claim 16 wherein the step of locating the position of the grommets includes the step of first establishing the position of the grommets nearest to the corners of the cover.

20. The method of claim 19 wherein the step of locating the position of the grommets includes the step of determining the position of a number of evenly spaced grommets between the grommets nearest to the corners of the cover.

21. The method of claim 20 further comprising the step of determining the maximum allowable spacing between the grommets, wherein the determined evenly spaced spacing between the grommets cannot exceed the maximum allowable spacing.

22. The method of claim 1 wherein the step of positioning grommets in the selected panel includes the step of selecting the position of the grommets, creating holes in the panel at the selected position of the grommets, and positioning a grommet in each hole.
